(19) United States
(12) Patent Application Publication
(10) Pub. No.: US 2017/0362136 A1
(43) Pub. Date: Dec. 21, 2017

(54) MICROENCAPSULATED NITRIFICATION INHIBITOR COMPOSITIONS

(71) Applicant: DOW AGROSCIENCES LLC, Indianapolis, IN (US)

(72) Inventors: Hiteshkumar DAVE, Collegeville, PA (US); Lei LIU, Indianapolis, IN (US); Raymond E. BOUCHER, JR., Indianapolis, IN (US); Greg POWELS, Indianapolis, IN (US)

(21) Appl. No.: 15/540,820

(22) PCT Filed: Dec. 23, 2015
(86) PCT No.: PCT/US15/00218

§ 371 Date: Jun. 29, 2017

Related U.S. Application Data
(60) Provisional application No. 62/098,971, filed on Dec. 31, 2014.

(51) Int. Cl. C05G 3/00; C05C 1/02; A01N 43/40; C05G 3/08; A01N 25/28

(52) U.S. Cl. CPC C05G 3/0017; C05G 3/08; A01N 25/28; A01N 43/40; C05C 1/02

(57) ABSTRACT

The present invention relates to an improved nitrification inhibitor composition and its use in agricultural applications.

### CROSS REFERENCE TO RELATED APPLICATION

This application claims priority to U.S. Provisional Patent Application Ser. No. 62/098,971, filed Dec. 31, 2014, the disclosure of which is hereby expressly incorporated by reference herein in its entirety.

### FIELD OF THE INVENTION

The present invention relates to an improved nitrification inhibitor composition and its use in agricultural applications.

### BACKGROUND AND SUMMARY

Nitrogen fertilizer added to the soil is readily transformed through a number of undesirable biological and chemical processes, including nitrification, leaching, and evaporation. Many transformation processes reduce the level of nitrogen available for uptake by the targeted plant. One such process is nitrification, a process by which certain widely occurring soil bacteria metabolize the ammonium form of nitrogen in the soil, transforming the nitrogen into nitrite and nitrate forms, which are more susceptible to nitrogen loss through leaching or volatilization via denitrification.

The decrease in available nitrogen due to nitrification necessitates the addition of more nitrogen rich fertilizer to compensate for the loss of agriculturally active nitrogen available to the plants. These concerns intensify the demand for improved management of nitrogen, in order to reduce costs associated with the use of additional nitrogen fertilizer.

Methods for reducing nitrification include treating soil with agriculturally active compounds that inhibit or at least reduce the metabolic activity of at least some microbes in the soil that contribute to nitrification. These compounds include (trichloromethyl)pyridines, such as nitrapyrin, which have been used as nitrification inhibitors in combination with fertilizers as described in U.S. Pat. No. 3,135,594, the disclosure of which is incorporated herein by reference in its entirety. These compounds help to maintain agriculturally-applied ammonium nitrogen in the ammonium form (stabilized nitrogen), thereby enhancing plant growth and crop yield. These compounds have been used efficaciously with a number of plant crops including corn, sorghum, and wheat.

Compounds such as nitrapyrin are unstable in soil in part because they are very volatile. For example, nitrapyrin has a relatively high vapor pressure (2.8×10⁻³ mm Hg at 23° Celsius), and because of this it has a tendency to volatilize and must be applied immediately or somehow protected from rapid loss after the fertilizer is treated with nitrapyrin. One approach is to add nitrapyrin to a volatile fertilizer, namely anhydrous ammonia which itself must be added to the soil in manner that reduces the amount of the volatile active lost to the atmosphere. This method is problematic in that it requires the use of anhydrous ammonia, which is corrosive and must be injected into the soil. This method of applying nitrapyrin, while stabilizing nitrapyrin below the soil surface, is not preferred. This method is unsuitable for many other fertilizer types and their standard application practices such as dry fertilizer granules, which most often are broadcasted onto the soil surface.

Still other approaches to stabilize nitrapyrin and reduce its loss to the atmosphere include applying it to the surface of the soil and then mechanically incorporating it into the soil, or watering it into the soil generally within 8 hours after its application to reduce its loss to the atmosphere. Still another approach is to encapsulated nitrapyrin for rapid or dump release. Such encapsulated forms of nitrapyrin have been formulated with lignin sulfonates as disclosed in U.S. Pat. No. 4,746,513, the disclosure of which is incorporated herein by reference in its entirety. While these formulations are less volatile than simple nitrapyrin, these formulations are better suited for use with liquid urea ammonium nitrate (“UAN”) or liquid manure fertilizers than with dry fertilizers. Although the release of nitrapyrin is delayed by the encapsulation, the capsules release all of the nitrapyrin upon contact with moisture, exhibiting the same stability and volatility disadvantages of the prior application methods.

Another approach to stabilizing nitrapyrin includes polycondensation encapsulation. Additional information regarding this approach can be found in U.S. Pat. No. 5,925,464 the disclosure of this patent is incorporated herein by reference in its entirety. Some of these formulations enhance handling safety and storage stability of the nitrapyrin using polyurethane rather than polyurea to form at least a portion of the capsule shell.

In some instances, polyurea microencapsulation has been used to produce enhanced nitrification inhibitor compositions for delayed, steady release of nitrification inhibitors for application with fertilizers. Such encapsulated forms of nitrapyrin are disclosed in U.S. Pat. No. 8,377,849 and U.S. Pat. No. 8,741,805, the disclosures of each of these patents is incorporated herein by reference in their entirety.

There remains a need to deliver nitrification inhibitors such as (trichloromethyl)pyridines, having greater long term stability in the field environment, while maintaining the level of efficacy of unencapsulated inhibitors.

Some aspects of the present disclosure include compositions that prevent and/or reduce crystal formation issues observed in presently commercially available formulations of nitrapyrin, including capsule suspensions. Crystal formation in nitrification inhibiting compositions can cause problems including filter blockage during field spray applications. In some instances, crystals that form in the liquid phase of an aqueous capsule suspension are high purity crystals, comprising substantially pure organic nitrification inhibitor, such as, for example, nitrapyrin. In some instances, high purity nitrapyrin (99 wt %) crystals form in presently available commercial formulations. Crystal formation, in some instances, is dependent upon the temperature of the formulation in storage, shipping, and/or transport of the formulations.

While aqueous suspensions of microencapsulated nitrapyrin referred to above are more stable than un-encapsulated nitrapyrin in an aqueous solution under certain conditions, it has been observed that crystals of nitrapyrin can form in the aqueous phase of a microcapsule suspension of nitrapyrin. Formation of crystalline nitrapyrin in an aqueous microcapsule suspension of nitrapyrin appears to be favored over a narrow temperature range of about −5° C. to about 15° C., more particularly about 0° C. to 10° C. (degrees centigrade). The weight percentage of crystalline nitrapyrin in the bulk aqueous phase of the microcapsule suspension accumulates over time. Depending upon how the microcapsule suspensions are handled, the presence of measurable levels of crystalline nitrapyrin in the aqueous phase can be of little-to-no consequence or problematic. The presence of even about 0.1 wt. percent crystalline nitrapyrin or above in the aqueous phase of the microcapsule suspension can be especially problematic if the suspension is applied by spraying the suspension through a fine point nozzle with a sprayer containing inline screens.

In some embodiments of the microcapsule suspension formulations disclosed herein, post addition (i.e. after microcapsule formation) of one or more polymeric crystal growth inhibitors to the aqueous phase reduces the rate of nitrapyrin crystal formation and/or growth in the aqueous phase at certain temperature storage conditions. In one embodiment, post addition of the one or more polymeric crystal growth inhibitors provides superior crystal growth reduction in cold temperature storage conditions. In one exemplary embodiment, such post-addition of the one or more polymeric crystal growth inhibitors include polymeric crystal growth inhibitors that are present in the aqueous phase of the formulation after the formation of the microcapsules. The term “polymeric crystal growth inhibitor” as used herein describes crystal growth inhibitors that are generally polymeric in nature and include, but are not limited to, acrylate polymers and copolymers, methacrylate polymers and copolymers, nonionic polymeric surfactants, anionic polymeric surfactants, polymeric dispersants, nonionic block copolymers, lignosulfonates and sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone such as, for example, with 1-hexadecene or with vinyl acetate, modified polyvinyl alcohols containing carboxyl groups, poly(alkylene) ethanolamides, polyvinylamines, modified styrene acrylic polymers, and latexes such as, for example, vinyl acrylic copolymer latexes and styrene butadiene latexes.

The present disclosure therefore provides compositions and methods to prevent and/or reduce crystal formation in agricultural active compositions containing organic nitrification inhibitors, such as nitrapyrin. In some embodiments, addition of polymeric crystal growth inhibitors prevent or reduce crystal formation in capsule suspensions of microencapsulated nitrapyrin. In some embodiments, polymeric crystal growth inhibitors provide superior physical stability at about 10° C. stability testing.

In certain embodiments, polymeric crystal growth inhibitors of the present disclosure could be applied to any agricultural active composition comprising one or more solvents, one or more agricultural active ingredients, and/or one or more nitrification inhibitors, optionally nitrapyrin.

Without the addition of one or more polymeric crystal growth inhibitors to the aqueous phase, the microcapsule suspension formulations of the present application may form nitrapyrin crystals in the aqueous phase at mild cold storage temperatures, about 10° C. The nitrapyrin crystals may be about 99% pure. Over time, such crystals may compose up to 0.5 weight percent of the overall microcapsule suspension formulation. However, crystals may also form at other temperatures, such as 0° C., −5° C., and 15° C. Polymeric crystal growth inhibitors can provide superior physical stability, particularly at mild cold storage temperatures at about 10° C., to prevent crystal formation in the aqueous phase of the microcapsule suspension.

Illustratively, polymeric crystal growth inhibitors include, but are not limited to: acrylate polymers and copolymers, methacrylate polymers and copolymers, nonionic polymeric surfactants, anionic polymeric surfactants, polymeric dispersants, nonionic block copolymers, lignosulfonates and sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone such as, for example, with 1-hexadecene or with vinyl acetate, modified polyvinyl alcohols containing carboxyl groups, poly(alkylene) ethanolamides, polyvinylamines, modified styrene acrylic polymers, and latexes such as, for example, vinyl acrylic copolymer latexes and styrene butadiene latexes. The polymeric crystal growth inhibitors described herein can be added to the microcapsule suspension formulation prior to crystal formation as a preventative measure to inhibit or prevent the formation of crystals of nitrapyrin.

Additionally, the microcapsule suspension formulations of the present disclosure can be combined or used in conjunction with pesticides, including arthropodicides, bactericides, fungicides, herbicides, insecticides, miticides, nematicides, nitrification inhibitors such as dicyandiamide, urease inhibitors such as N-(n-butyl) thiophosphoric triamide, and the like or pesticidal mixtures and synergistic mixtures thereof. In such applications, the microcapsule suspension formulation of the present disclosure can be tank mixed with the desired pesticide(s) or they can be applied sequentially.

Therefore, in a first embodiment, a microcapsule suspension formulation is disclosed comprising a suspended phase of a plurality of microcapsules, said microcapsules having a volume median particle size of from about 1 to about 10 microns, wherein a microcapsule comprises a microcapsule wall produced by an interfacial polycondensation reaction between a polymeric isocyanate and a polyamine to form a polyurea shell having a weight percentage of about 0.2 to about 15 percent of a total weight of the microcapsule suspension formulation, and a compound encapsulated within the polyurea shell wherein said compound is 2-chloro-6-(trichloromethyl)pyridine, and an aqueous phase including at least one polymeric crystal growth inhibitor.

In a second embodiment, the at least one polymeric crystal growth inhibitor of the first embodiment reduces formation of crystalline 2-chloro-6-(trichloromethyl)pyridine in the aqueous phase of the suspension. The aqueous phase of the first embodiment may comprise about 0.5 or about 1.0 wt. % to about 10 wt. % of the at least one polymeric crystal growth inhibitor.

In a third embodiment, the at least one polymeric crystal growth inhibitor of any of the preceding embodiments is selected from the group consisting of: acrylate polymers and copolymers, methacrylate polymers and copolymers, nonionic polymeric surfactants, anionic polymeric surfactants, polymeric dispersants, nonionic block copolymers, lignosulfonates and sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone such as, for example, with 1-hexadecene or with vinyl acetate, modified polyvinyl alcohols containing carboxyl groups, poly(alkylene) ethanolamides, polyvinylamines, modified styrene acrylic polymers, and latexes such as, for example, vinyl acrylic copolymer latexes and styrene butadiene latexes, and mixtures thereof.

In a fourth embodiment, the at least one polymeric crystal growth inhibitor of any of the preceding embodiments is selected from the group consisting of: a nonionic polymeric surfactant with a low HLB including a hydrophilic portion of polyethylene oxide (PEG) and a hydrophobic portion of poly 12-hydroxystearic acid (pHSA) or alkyd resin, a poly(isobutylene) ethanolamide, a homopolymer of hexadecyl 1-ethenyl-2-pyrrolidinone, a polyethylene-polypropylene glycol monobutyl ether, a polymeric dispersant, a nonionic block copolymer, a high acrylate, vinyl acrylic copolymer latex, and a styrene-butadiene polymer latex.

In a fifth embodiment, the at least one polymeric crystal growth inhibitor of any of the preceding embodiments is selected from the group consisting of: a nonionic polymeric surfactants with a low HLB including a hydrophilic portion of polyethylene oxide (PEG) and a hydrophobic portion of poly 12-hydroxystearic acid (pHSA) or alkyd resin, a poly(isobutylene) ethanolamide, and a homopolymer of hexadecyl 1-ethenyl-2-pyrrolidinone.

In a sixth embodiment, the at least one polymeric crystal growth inhibitor of any of the preceding embodiments is selected from the group consisting of: a polyethylene-polypropylene glycol monobutyl ether, a polymeric dispersant, a nonionic block copolymer, a high acrylate, vinyl acrylic copolymer latex, and a styrene-butadiene polymer latex.

In a seventh embodiment, the at least one polymeric crystal growth inhibitor comprises a portion of the formulation of any of the preceding embodiments in any weight percent range selected from the group consisting of: between about 2.00 wt. % and about 3.00 wt. %, between about 1.00 wt. % and about 5.00 wt. %, between about 0.50 wt. % and about 7.50 wt. %, and between about 0.01 wt. % and about 10.00 wt. %.

In an eighth embodiment, a fertilizer composition is disclosed comprising a nitrogen fertilizer, and the microcapsule suspension formulation according to any of the preceding embodiments.

In a ninth embodiment, the nitrogen fertilizer of the eighth embodiment is an ammonium or organic nitrogen fertilizer.

In a tenth embodiment, a method is disclosed for suppressing the nitrification of ammonium nitrogen in a growth medium comprising the step of: applying the microcapsule suspension formulation of any of the preceding embodiments to said growth medium.

In an eleventh embodiment, the formulation of any of the preceding embodiments is incorporated into the growth medium.

In a twelfth embodiment, the formulation of any of the preceding embodiments is applied to a growth medium surface.

In a thirteenth embodiment, the formulation of any of the preceding embodiments is applied in combination with a pesticide or sequentially with a pesticide.

In a fourteenth embodiment, the formulation of any of the preceding embodiments is applied with a nitrogen fertilizer.

In a fifteenth embodiment, the nitrogen fertilizer of any of the preceding embodiments is urea ammonium nitrate.

In a sixteenth embodiment, a method is disclosed for reducing crystal formation in a microcapsule suspension formulation comprising the steps of preparing a microcapsule suspension formulation comprising (a) a suspended phase of a plurality of microcapsules, said microcapsules having a volume median particle size of from about 1 to about 10 microns, wherein a microcapsule comprises (1) a microcapsule wall produced by an interfacial polycondensation reaction between a polymeric isocyanate and a polyamine to form a polyurea shell having a weight percentage of about 0.2 to about 15 percent of a total weight of the microcapsule suspension formulation, and (2) a compound encapsulated within the polyurea shell wherein said compound is 2-chloro-6-(trichloromethyl)pyridine; and (b) an aqueous phase, optionally including an ionic stabilizer, and combining the microcapsule suspension with at least one polymeric crystal growth inhibitor

In a seventeenth embodiment, the step of combining of the sixteenth embodiment is performed substantially simultaneously with step of preparing the microcapsule suspension.

In an eighteenth embodiment, the step of combining of any of the preceding embodiments is performed after the step of preparing the microcapsule suspension.

In a nineteenth embodiment, the step of combining of any of the preceding embodiments is performed during transport of the microcapsule suspension.

In a twentieth embodiment, the at least one polymeric crystal growth inhibitor of any of the preceding embodiments is selected from the group consisting of: acrylate polymers and copolymers, methacrylate polymers and copolymers, nonionic polymeric surfactants, anionic polymeric surfactants, polymeric dispersants, nonionic block copolymers, lignosulfonates and sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone such as, for example, with 1-hexadecene or with vinyl acetate, modified polyvinyl alcohols containing carboxyl groups, poly(alkylene) ethanolamides, polyvinylamines, modified styrene acrylic polymers, and latexes such as, for example, vinyl acrylic copolymer latexes and styrene butadiene latexes.

In a twenty-first embodiment, the at least one polymeric crystal growth inhibitor of any of the preceding embodiments is selected from the group consisting of: a nonionic polymeric surfactant with a low HLB containing a hydrophilic portion of polyethylene oxide (PEG) and a hydrophobic portion of poly 12-hydroxystearic acid (pHSA) or alkyd resin, a poly(isobutylene) ethanolamide, a homopolymer of hexadecyl 1-ethenyl-2-pyrrolidinone, a polyethylene-polypropylene glycol monobutyl ether, a polymeric dispersant, a nonionic block copolymer, a high acrylate, vinyl acrylic copolymer latex, and a styrene-butadiene polymer latex.

In a twenty-second embodiment, the at least one polymeric crystal growth inhibitor of any of the preceding embodiments is selected from the group consisting of: nonionic polymeric surfactants with a low HLB containing a hydrophilic portion of polyethylene oxide (PEG) and a hydrophobic portion of poly 12-hydroxystearic acid (pHSA) or alkyd resin, a poly(isobutylene) ethanolamide, and a homopolymer of hexadecyl 1-ethenyl-2-pyrrolidinone.

In a twenty-third embodiment, the at least one polymeric crystal growth inhibitor of any of the preceding embodiments is selected from the group consisting of: polyethylene-polypropylene glycol monobutyl ethers, a polymeric dispersant, a nonionic block copolymer, a high acrylate, vinyl acrylic copolymer latex, and a styrene-butadiene polymer latex.

In a twenty-fourth embodiment, the at least one polymeric crystal growth inhibitor of any of the preceding embodiments comprises a portion of the formulation in any weight percent range selected from the group consisting of: between about 2.00 wt. % and about 3.00 wt. %, between about 1.00 wt. % and about 5.00 wt. %, between about 0.50 wt. % and about 7.50 wt. %, and between about 0.01 wt. % and about 10.00 wt. %.

In a twenty-fifth embodiment, the suspension of any of the preceding embodiments comprises between about 1.00% by weight and about 3.00% by weight of the polymeric crystal growth inhibitor.

In a twenty-sixth embodiment, the aqueous phase of any of the preceding embodiments comprises between about 1.00 wt. % and about 5.00 wt. % of the polymeric crystal growth inhibitor that reduces formation of crystalline 2-chloro-6-(trichloromethyl)pyridine in the aqueous phase of the suspension.

In a twenty-seventh embodiment, the aqueous phase of any of the preceding embodiments comprises between about 0.5 and about 10 wt. % of at least one polymeric crystal growth inhibitor that reduces formation of crystalline 2-chloro-6-(trichloromethyl)pyridine in the aqueous phase of the suspension.

In a twenty-eighth embodiment, the method of any of the preceding embodiments further comprises combining the microcapsule suspension with an ammonium or organic nitrogen fertilizer.

In yet still other embodiments, the ratio of the suspended phase a) to the aqueous phase b) is from about 1:0.75 to about 1:20. In some embodiments, the ratio of the suspended phase a) to the aqueous phase b) is from about 1:1 to about 1:7.

In other embodiments, the ratio of the suspended phase a) to the aqueous phase b) of the microcapsule suspension is from about 1:1 to about 1:4. In some exemplary embodiments, the polymeric isocyanate is polymethylene polyphenylisocyanate. In still some other exemplary embodiments, the polyamine is selected from ethylenediamine and diethylenetriamine. In some embodiments, the method further comprises the step of combining the microcapsule suspension with a nitrogen fertilizer. In some embodiments of the method, the nitrogen fertilizer is urea ammonium nitrate.

Additionally disclosed is a microcapsule suspension formulation comprising a suspended phase of a plurality of microcapsules having a volume median particle size of from about 1 to about 10 microns, wherein a microcapsule comprises a microcapsule wall produced by an interfacial polycondensation reaction between a polymeric isocyanate and a polyamine to form a polyurea shell having a weight percentage of about 0.2 to about 15 percent of a total weight of the microcapsule suspension formulation, and a compound encapsulated within the polyurea shell wherein said compound is 2-chloro-6-(trichloromethyl)pyridine; and an aqueous phase including an ionic stabilizer and at least one polymeric crystal growth inhibitor selected from the group consisting of, but not limited to: acrylate polymers and copolymers, methacrylate polymers and copolymers, nonionic polymeric surfactants, anionic polymeric surfactants, polymeric dispersants, nonionic block copolymers, lignosulfonates and sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone such as, for example, with 1-hexadecene or with vinyl acetate, modified polyvinyl alcohols containing carboxyl groups, poly(alkylene) ethanolamides, polyvinylamines, modified styrene acrylic polymers, and latexes such as, for example, vinyl acrylic copolymer latexes and styrene butadiene latexes, and mixtures thereof.

In some exemplary embodiments, the aqueous microcapsule suspension formulation comprises between about 1% by weight and about 5% by weight of the polymeric crystal growth inhibitor. In other embodiments, the aqueous phase of the microcapsule suspension formulation comprises about 1.0% by weight to about 3.0% by weight of the polymeric crystal growth inhibitor that reduces formation of crystalline 2-chloro-6-(trichloromethyl)pyridine in the aqueous phase of the suspension. Still in other embodiments, the aqueous phase of the microcapsule suspension comprises between about 0.5 and about 10 weight percent of the polymeric crystal growth inhibitor that reduces formation of crystalline 2-chloro-6-(trichloromethyl)pyridine in the aqueous phase of the suspension.

Still in yet other embodiments, the ratio of the suspended phase a) to the aqueous phase b) in the formulation is from about 1:0.75 to about 1:20. In some embodiments, the ratio of the suspended phase a) to the aqueous phase b) is from about 1:1 to about 1:7. In still other embodiments, the ratio of the suspended phase a) to the aqueous phase b) is from about 1:1 to about 1:4. Still in other embodiments, the polymeric isocyanate is polymethylene polyphenylisocyanate. In some embodiments, the polyamine is selected from ethylenediamine and diethylenetriamine.

### DETAILED DESCRIPTION

(Trichloromethyl)pyridine compounds useful in the composition of the present disclosure include compounds having a pyridine ring which is substituted with at least one trichloromethyl group and mineral acid salts thereof. Suitable compounds include those containing chlorine or methyl substituents on the pyridine ring in addition to a trichloromethyl group, and are inclusive of chlorination products of methyl pyridines such as lutidine, collidine and picoline. Suitable salts include hydrochlorides, nitrates, sulfates and phosphates. The (trichloromethyl)pyridine compounds useful in the practice of the present disclosure are typically oily liquids or crystalline solids dissolved in a solvent. Other suitable compounds are described in U.S. Pat. No. 3,135,594. A preferred (trichloromethyl)pyridine is 2-chloro-6-(trichloromethyl)pyridine, also known as nitrapyrin, and the active ingredient of the product N-SERVE™. (Trademark of Dow AgroSciences LLC).

The utility of compounds such as nitrapyrin has been greatly increased by encapsulating such compounds along with suitable solvents in microcapsules. Especially useful microcapsules are comprised of a nitrapyrin/hydrophobic solvent core surround by a polyurea shell. Microcapsules of appropriate volume, shell thickness, and composition can be suspended in, stored in, and applied in an aqueous phase. Such useful formulations are disclosed in U.S. patent application Ser. No. 12/393,661 filed on Feb. 26, 2009, publication number U.S. 2009-0227458 A1 published on Sep. 10, 2009, and now issued as U.S. Pat. No. 8,741,805 issued on Jun. 3, 2014; U.S. patent application Ser. No. 12/009,432, filed Jan. 18, 2008, publication number U.S. 2008-0176745 A1 published on Jul. 24, 2008, and now issued as U.S. Pat. No. 8,377,849 issued on Feb. 19, 2013; and U.S. Provisional Application Ser. No. 60/881,680 filed on Jan. 22, 2007, which are all expressly incorporated by reference herein in their entirety as if each were incorporated by reference individually.

While the microcapsule aqueous suspensions referred to above are more stable than un-encapsulated nitrapyrin in an aqueous solution under certain conditions, it has been observed that crystals of nitrapyrin can form in the aqueous phase of a microcapsule suspension of nitrapyrin. Formation of crystalline nitrapyrin in an aqueous microcapsule suspension of nitrapyrin appears to be favored over a narrow temperature range of about −5° C. to about 15° C., more particularly about 0° C. to 10° C. (degrees centigrade). The weight percentage of crystalline nitrapyrin in the bulk aqueous phase of the microcapsule suspension accumulates over time. Depending upon how the microcapsule suspensions are handled, the presence of measurable levels of crystalline nitrapyrin in the aqueous phase can be of little-to-no consequence or problematic. The presence of even about 0.1 wt. percent crystalline nitrapyrin or above in the aqueous phase of the microcapsule suspension can be especially problematic if the suspension is applied by spraying the suspension through a fine point nozzle with a sprayer containing inline screens.

In order to inhibit or at least appreciably slow the formation of nitrapyrin crystals in the aqueous phase, disclosed herein is a microcapsule suspension formulation composition that includes about 1 wt. percent of a polymeric crystal growth inhibitor present in the aqueous phase of the microcapsule suspension. In some embodiments, the polymeric crystal growth inhibitor is added to the aqueous phase of the microcapsule suspension before the accumulation of a problematic level of crystalline nitrapyrin in the aqueous phase.

Also disclosed herein are microcapsule suspension formulations that include at least one polymeric crystal growth inhibitor present in the aqueous phase of the microcapsule suspension. In some embodiments, the polymeric crystal growth inhibitor is added to the aqueous phase of the microcapsule suspension before the accumulation of a problematic level of crystalline nitrapyrin in the aqueous phase.

The polymeric crystal growth inhibitor of the present disclosure can be added to capsule suspensions of polyurea microencapsulated nitrapyrin in any weight percent range formed between any lower amount including about 0.01 wt. %, about 0.05 wt. %, about 0.10 wt. %, about 0.25 wt. %, about 0.50 wt. %, about 0.75 wt. %, and about 1.00 wt. % and any upper amount including about 10.00 wt. %, about 7.50 wt. %, about 5.00 wt. %, about 3.00 wt. %, about 2.50 wt. %, about 2.00 wt. %, and about 1.50 wt. %.

In some embodiments, the polymeric crystal growth inhibitor of the present disclosure can be added to capsule suspensions of polyurea microencapsulated nitrapyrin in any weight percent range selected from the group consisting of: between about 2.00 wt. % and about 3.00 wt. %, between about 1.00 wt. % and about 5.00 wt. %, between about 0.50 wt. % and about 7.50 wt. %, and between about 0.01 wt. % and about 10.00 wt. %.

Examples of typical solvents which can be used to dissolve crystalline (trichloromethyl)pyridine compounds in the organic phase in the preparation of microcapsules include aromatic solvents, particularly alkyl substituted benzenes such as xylene or propylbenzene fractions, and mixed naphthalene and alkyl naphthalene fractions; mineral oils; kerosene; dialkyl amides of fatty acids, particularly the dimethylamides of fatty acids such as the dimethyl amide of caprylic acid; chlorinated aliphatic and aromatic hydrocarbons such as 1,1,1-trichloroethane and chlorobenzene; esters of glycol derivatives, such as the acetate of the n-butyl, ethyl, or methyl ether of diethyleneglycol and the acetate of the methyl ether of dipropylene glycol; ketones such as isophorone and trimethylcyclohexanone (dihydroisophorone); and the acetate products such as hexyl or heptyl acetate. The preferred organic liquids are xylene, alkyl substituted benzenes, such as propyl benzene fractions, and alkyl naphthalene fractions.

In general, the amount of solvent employed in the preparation of the microcapsules, if desired, is typically from about 40, preferably from about 50 to about 70, preferably to about 60 weight percent, based on the total weight of a (trichloromethyl)pyridine/solvent solution. The amount of (trichloromethyl)pyridine within a (trichloromethyl) pyridine/solvent solution is typically from about 30, preferably from about 40 to about 60, preferably to about 50 weight percent, based on the weight of a (trichloromethyl)pyridine/solvent solution.

The microcapsules useful in the present disclosure can be prepared by the polycondensation reaction of a polymeric isocyanate and a polyamine to form a polyurea shell. Methods of microencapsulation are well known in the art and any such method can be utilized in the present disclosure to provide the capsule suspension formulation. In general, the capsule suspension formulation can be prepared by first mixing a polymeric isocyanate with a (trichloromethyl)pyridine/solvent solution. This mixture is then combined with an aqueous phase which includes an emulsifier to form a two phase system. The organic phase is emulsified into the aqueous phase by shearing until the desired particle size is achieved. An aqueous crosslinking polyamine solution is then added dropwise while stirring to form the encapsulated particles of (trichloromethyl)pyridine in an aqueous suspension.

The desired particle size and cell wall thickness will depend upon the actual application. The microcapsules typically have a volume median particle size of from about 1 to about 10 microns and a capsule wall thickness of from about 10 to about 125 nanometers. In one embodiment, wherein the formulation of the present disclosure will be incorporated immediately into a growth medium, the desired particle size may be from about 2 to about 10 microns, with a cell wall of from about 10 to about 25 nanometers. In another embodiment, requiring soil surface stability, the desired particle size may be from about 1-5 microns, with cell wall thicknesses of from about 75 to about 125 nanometers.

Other conventional additives may also be incorporated into the formulation such as, for example, emulsifiers, dispersants, thickeners, biocides, pesticides, salts and film-forming polymers.

Dispersing and emulsifying agents include condensation products of alkylene oxides with phenols and organic acids, alkyl aryl sulfonates, polyoxyalkylene derivatives of sorbitan esters, complex ether alcohols, mahogany soaps, lignin sulfonates, polyvinyl alcohols, and the like. The surface-active agents are generally employed in the amount of from about 1 to about 20 percent by weight of the microcapsule suspension formulation.

The ratio of the suspended phase to the aqueous phase within the microcapsule suspension formulation of the present disclosure is dependent upon the desired concentration of (trichloromethyl)pyridine compound in the final formulation. Typically the ratio will be from about 1:0.75 to about 1:20. Generally the desired ratio is about 1:1 to about 1:7, and is preferably from about 1:1 to about 1:4.

The presence of a (trichloromethyl) pyridine compound suppresses the nitrification of ammonium nitrogen in the soil or growth medium, thereby preventing the rapid loss of ammonium nitrogen originating from nitrogen fertilizers, organic nitrogen constituents, or organic fertilizers and the like.

Generally, the microcapsule suspension formulations of the present disclosure are applied such that the (trichloromethyl)pyridine compound is applied to the soil or a growth medium at a rate of from about 0.5 to about 1.5 kg/hectare, preferably at a rate of from about 0.58 to about 1.2 kg/hectare. The preferred amount can be easily ascertained by the application preference, considering factors such as soil pH, temperature, soil type and mode of application.

The microcapsule suspension formulation of the present disclosure can be applied in any manner which will benefit the crop of interest. In one embodiment, the microcapsule suspension formulation is applied to growth medium in a band or row application. In another embodiment, the formulation is applied to or throughout the growth medium prior to seeding or transplanting the desired crop plant. In yet another embodiment, the formulation can be applied to the root zone of growing plants.

Additionally, the microcapsule suspension formulation can be applied with the application of nitrogen fertilizers. The formulation can be applied prior to, subsequent to, or simultaneously with the application of fertilizers.

The microcapsule suspension formulation of the present disclosure has the added benefit that it can be applied to the soil surface, without additional water or mechanical incorporation into the soil for days to weeks. Alternatively, if desired, the formulation of the present disclosure can be incorporated into the soil directly upon application.

The microcapsule suspension formulation of the present disclosure typically has a concentration of (trichloromethyl)pyridine compound in amounts of from about 5, preferably from about 10 and more preferably from about 15 to about 40, typically to about 35, preferably to about 30 and more preferably to about 25 percent by weight, based on the total weight of the microcapsule suspension formulation. The microcapsule suspension formulation is then mixed with a solvent or water to obtain the desired rate for application.

Soil treatment compositions may be prepared by dispersing the microcapsule suspension formulation in or on a fertilizer such as ammonium or organic nitrogen fertilizer. The resulting fertilizer composition may be employed as such or may be modified, as by dilution with additional nitrogen fertilizer or with inert solid carrier to obtain a composition containing the desired amount of active agent for treatment of soil.

The soil may be prepared in any convenient fashion with the microcapsule suspension formulation of the present disclosure, including mechanically mixed with the soil; applied to the surface of the soil and thereafter dragged or diced into the soil to a desired depth; or transported into the soil such as by injection, spraying, dusting or irrigation. In irrigation applications, the formulation may be introduced to irrigation water in an appropriate amount in order to obtain a distribution of the (trichloromethyl)pyridine compound to the desired depth of up to 6 inches (15.24 cm.).

Surprisingly, once incorporated into the soil, the microcapsule suspension formulation of the present disclosure outperforms other nitrapyrin formulations, especially unencapsulated versions. It was thought that the encapsulated composition would not release nitrapyrin sufficiently to be as effective as the non-encapsulated versions, wherein the diffusion from the capsule would be too slow to provide a biological effect, but in fact, the opposite effect is observed.

Due to the controlled release of nitrapyrin in the microcapsule suspension formulation of the present disclosure, several advantages can be attained. First, the amount of nitrapyrin can be reduced since it is more efficiently released into the soil over an extended period of time. Additionally, the microcapsule suspension formulation of the present disclosure can be applied and left on the surface to be naturally incorporated into the soil, without the need for mechanical incorporation if desired.

In some embodiments of the microcapsule suspension formulation, post addition (i.e. after microcapsule formation) of one or more polymeric crystal growth inhibitors to the aqueous phase reduces the rate of crystal formation and/or growth in the aqueous phase at certain temperature storage conditions. In one embodiment, post-addition of polymeric crystal growth inhibitors provide superior crystal growth reduction in cold temperature storage conditions. In an exemplary embodiment, such post-addition of polymeric crystal growth inhibitors places them in the aqueous phase of the formulation after the formation of the microcapsules.

In some embodiments, the polymeric crystal growth inhibitors may include one or more of: acrylate polymers and copolymers, methacrylate polymers and copolymers, nonionic polymeric surfactants, anionic polymeric surfactants, polymeric dispersants, nonionic block copolymers, lignosulfonates and sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone such as, for example, with 1-hexadecene or with vinyl acetate, modified polyvinyl alcohols containing carboxyl groups, poly(alkylene) ethanolamides, polyvinylamines, modified styrene acrylic polymers, and latexes such as, for example, vinyl acrylic copolymer latexes and styrene butadiene latexes.

Without the addition of one or more polymeric crystal growth inhibitors to the aqueous phase, the microcapsule suspension formulation of the present application may form nitrapyrin crystals in the aqueous phase at mild cold storage temperatures, about 10° C. The nitrapyrin crystals may be about 99% pure. Over time, such crystals may compose up to 0.5 weight percent of the overall microcapsule suspension formulation. However, crystals may also form at other temperatures, such as 0° C., −5° C., and 15° C. Use of polymeric crystal growth inhibitors can provide superior physical stability, particularly at mild cold storage temperatures of about 10° C., to prevent crysta¹ formation in the aqueous phase of the microcapsule suspension.

Illustratively, post-added polymeric crystal growth inhibitors include: Alcosperse 725 (hydrophobically modified copolymer), Reax 85A (sulfonation kraft lignin dispersants), Metasperse 500L (polymeric surfactant), Atlox 4914 (nonionic polymeric surfactant containing a hydrophilic portion of polyethylene oxide (PEG) and a hydrophobic portion of poly 12-hydroxystearic acid (pHSA) or alkyd resin), Hypermer 2422 (poly(isobutylene) ethanolamide), Polyfon H (28% soln, lignosulfonate), Agrimer AL22 (homopolymer of hexadecyl 1-ethenyl-2-pyrrolidinone), Pluronic P84 (nonionic block copolymer), Soprophor FLK (ethoxylated tristyrylphenol phosphate potassium salt), Toximul 8320 (polyethylene-polypropylene glycol monobutyl ether), Lupamin 4500 (polyvinylamine), Solsperse 16000 (polymeric dispersant), Agrimer VA 71 (linear random copolymer of vinylpyrrolidone and vinyl acetate), Agrimer 60L (1-ethenyl-2-pyrrolindinone, homopolymer), Kararay KL-318 (modified polyvinyl alcohols containing carboxyl groups), Hypermer B203 (nonionic block copolymer), Solsperse 13940 (polymeric dispersant), Encor 162 (high acrylate, vinyl acrylic copolymer latex), and latex XU30570.51 (styrene-butadiene polymer latex).

In some embodiments, preferred, post-added polymeric crystal growth inhibitors include: Atlox 4914 (nonionic polymeric surfactant containing a hydrophilic portion of polyethylene oxide (PEG) and a hydrophobic portion of poly 12-hydroxystearic acid (pHSA) or alkyd resin, a low HLB surfactant), Hypermer 2422 (poly(isobutylene) ethanolamide), Agrimer AL22 (homopolymer of hexadecyl 1-ethenyl-2-pyrrolidinone), Toximul 8320 (polyethylene-polypropylene glycol monobutyl ether), Solsperse 16000 (polymeric dispersant), Hypermer B203 (nonionic block copolymer), Solsperse 13940 (polymeric dispersant), Encor 162 (high acrylate, vinyl acrylic copolymer latex), and latex XU30570.51 (styrene-butadiene polymer latex).

Additionally, the microcapsule suspension formulations of the present disclosure can be combined or used in conjunction with pesticides, including arthropodicides, pesticides, bactericides, fungicides, herbicides, insecticides, miticides, nematicides, nitrification inhibitors such as dicyandiamide, urease inhibitors such as N-(n-butyl) thiophosphoric triamide, and the like or pesticidal mixtures and synergistic mixtures thereof. In such applications, the microcapsule suspension formulation of the present disclosure can be tank mixed with the desired pesticide(s) or they can be applied sequentially.

Exemplary herbicides include, but are not limited to acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like

Exemplary insecticides include, but are not limited to 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A &B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methyl sulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vamidothion, vaniliprole, vaniliprole, XMC, xylylcarb, zeta cypermethrin and zolaprofos.

Additionally, any combination of the above pesticides can be used.

Additionally, Rynaxypyr™, a new anthranilic diamide (Chlorantraniliprole) crop protection chemistry from DuPont with efficacy in controlling target pests can be used.

As used throughout the specification, the term “about” refers to plus or minus 10% of the stated value, for example the term ‘about 1.0’ includes values from 0.9 to 1.1.

The following examples are provided to illustrate the present invention. The examples are not intended to limit the scope of the present invention and they should not be so interpreted. Amounts are in weight parts or weight percentages unless otherwise indicated.

### EXAMPLES

### Use of Polymeric Crystal Growth Inhibitors to Prevent Nitrapyrin Crystal Growth in Instinct® Formulations

Amounts of a commercially available liquid emulsion of nitrapyrin microencapsulated with polyurea (Instinct® formulation (GF-3181); contains 17.79 wt % mitrapyrin) were weighted into 250 mL glass bottles (˜195 g GF-3181). The exemplary polymeric crystal growth inhibitors (in original product form or prepared as stock solution) were each added directly into the GF-3181 based on the weight percent listed in Tables I and II. In case of usage of stock solution, weight % indicates stock solution quantity. Weight % corresponds to the quantity of trade products used as purchased (additive trade). The vials were then agitated on a linear shaker for 30-45 minutes to prepare a uniform distribution and to dissolve inhibitors in the Instinct® formulation. Once a homogeneous formulation was achieved, sample bottles were placed in a refrigerator at 10° C. All samples were tested for crystallization stability at different time intervals (as shown in Table I) and compared against GF-3181 (no additive) control formulation.

The wet sieve procedure (determining crystal wt. % in the 10° C. storage samples) was carried out as follows: Approximately 20 g of sample were added to a glass beaker containing between 100 and 200 grams of tap water. The solution was stirred using a glass stir rod and then poured through at 75 μm mesh sieve. The beaker was rinsed with additional water and the rinse was also poured through the sieve. Tap water was poured over the sample in the sieve for approximately 30 seconds to rinse weak agglomerates through. The residual left on the screen was rinsed onto a tared filter paper and vacuum filtered. This filler paper with sample was allowed to dry in a vacuum hood for at least four hours and then re-weighed. Residue percentages were calculated using the equation: Residue Percentage=(Filter paper and Residue Weight After Drying(g)−Filter Paper Weight(g))/(Total Sample Sieved(g)).

This process was repeated for each sample stored at 10° C. at different time intervals and residue weight percentages were recorded as listed in Tables I and Table II. Toximul 8320, Agrimer AL 22, Hypermer 2422, and Atlox 4914 showed less wet sieve residue weight percentages compared to control GF-3181 formulation after 70 days of storage at 10° C. Based on Table I screening results, Solsperse 16000, Kararay KL-318 (10%), Hypermer B203, and Solsperse 13940 showed less wet sieve residue wt % compared to control GF-3181 formulation after 14 days of storage at 10° C.

TABLE I
Wet sieve testing of polymeric crystal growth inhibitors post-added to polyurea
microencapsulated nitrapyrin suspension (Instinct ® formulation GF-3181) and
stored at 10° C. for crystallization stability determination. All samples with polymeric
crystal growth inhibitors were tested against control (GF-3181) which contains no additive.

| | | | | Wet | # of |
|---|---|---|---|---|---|
| | Crystal | | | sieve | Days at |
| | Inhibitors | | Inhibitor | residue | 10° C. |
| Sample # | (Trade Name) | Chemistry | wt % | wt % | storage |
| 1 | Control | n/a | — | 0.253% | 21 |
| 2 | Alcosperse 725 | hydrophobically modified | 2.50% | 0.212% | 21 |
| | | copolymer (carboxylated and | | | |
| | | non-carboxylated monomers | | | |
| | | combining hydrophobic | | | |
| | | character, aromatic structure | | | |
| | | and high charge density) | | | |
| 3 | Atlox 4914 | nonionic polymeric | 2.87% | 0.011% | 21 |
| | | surfactant with a low HLB | | | |
| 4 | Hypermer 2422 | Poly (isobutylene) | 2.85% | 0.014% | 21 |
| | | ethanolamide | | | |
| 7 | Reax 85A | sulfonation kraft lignin | 3.33% | 0.169% | 21 |
| | | dispersants | | | |
| 8 | Metasperse | polymeric surfactant | 3.34% | 0.199% | 21 |
| | 500L | | | | |
| 9 | Reax 83A | sulfonation kraft lignin | 3.34% | 0.302% | 21 |
| | | dispersants | | | |
| 10 | Polyfon T | lignosulfonate | 3.34% | 0.255% | 21 |
| 11 | Jeffamine T- | epoxy curing agent | 2.85% | 0.394% | 21 |
| | 403 | (polyetheramine, | | | |
| | | polyoxypropylene triamine) | | | |
| 13 | Atlox 4913 | hydrophilic methyl | 2.87% | 0.359% | 21 |
| | | methacrylate graft copolymer | | | |
| | | (Acrylic copolymer solution) | | | |
| 15 | Polyfon H | lignosulfonate | 3.58% | 0.135% | 21 |
| | (28% soln) | | | | |
| 16 | Agrimer AL22 | 2-Pyrrolidinone, 1-ethenyl, | 2.85% | 0.017% | 21 |
| | | hexadecyl homopolymer | | | |
| 17 | Pluronic P84 | nonionic block copolymer | 1.01% | 0.207% | 21 |
| 18 | Ethomeen T | Bis (2-hydroxyethyl) | 2.86% | 0.545% | 21 |
| | 18/H | octadecylamine | | | |
| 19 | Soprophor FLK | ethoxylated tristyrylphenol | 2.86% | 0.218% | 21 |
| | | phosphate potassium salt | | | |
| 20 | Toximul 8320 | Polyethylene-polypropylene | 2.86% | 0.007% | 21 |
| | | glycol monobutyl ether | | | |
| 21 | Lupamin 4500 | polyvinylamine | 2.86% | 0.200% | 21 |
| 1 | Control | n/a | — | 0.385% | 32 |
| 3 | Atlox 4914 | nonionic polymeric | 2.87% | 0.196% | 32 |
| | | surfactant with a low HLB | | | |
| 4 | Hypermer 2422 | poly(isobutylene) | 2.85% | 0.001% | 32 |
| | | ethanolamide | | | |
| 16 | Agrimer AL22 | 2-Pyrrolidinone, 1-ethenyl, | 2.85% | 0.080% | 32 |
| | | hexadecyl homopolymer | | | |
| 20 | Toximul 8320 | Polyethylene-polypropylene | 2.86% | 0.285% | 32 |
| | | glycol monobutyl ether | | | |
| 1 | Control | n/a | — | 0.425% | 70 |
| 3 | Atlox 4914 | nonionic polymeric | 2.87% | 0.428% | 70 |
| | | surfactant with a low HLB | | | |
| 4 | Hypermer 2422 | poly(isobutylene) | 2.85% | 0.104% | 70 |
| | | ethanolamide | | | |
| 16 | Agrimer AL22 | 2-Pyrrolidinone, 1-ethenyl, | 2.85% | 0.292% | 70 |
| | | hexadecyl homopolymer | | | |
| 20 | Toximul 8320 | Polyethylene-polypropylene | 2.86% | 0.377% | 70 |
| | | glycol monobutyl ether | | | |

TABLE II
Wet sieve testing of polymeric crystal growth inhibitors post added to the Instinct ®
formulation (GF-3181) and stored at 10° C. for crystallization stability. All samples with
polymeric crystal growth inhibitors were tested against control (GF-3181) without any
additive.

| | Crystal | | | | |
|---|---|---|---|---|---|
| | Inhibitors (post | | | | # of Days at |
| | addition in GF- | | Inhibitor | Wet sieve | 10° C. |
| Sample # | 3181) | Chemistry | wt % | residue wt % | storage |
| 22 | Control | n/a | — | 0.23% | 14 |
| 23 | Solsperse 16000 | polymeric | 1.02% | 0.00% | 14 |
| | | dispersant | | | |
| 24 | Agrimer VA 71 | linear random | 2.49% | 0.20% | 14 |
| | | copolymer | | | |
| | | (vinylpyrrolidone & | | | |
| | | vinyl acetate) | | | |
| 25 | Agrimer 60L | 2-pyrrolindinone, | 1.05% | 0.21% | 14 |
| | | 1-ethenyl- | | | |
| | | homopolymer | | | |
| 26 | 20% Celvol205 | partially hydrolyzed | 4.99% | 0.30% | 14 |
| | | polyvinyl alcohol | | | |
| 27 | Kararay KL- | modified polyvinyl | 7.15% | 0.15% | 14 |
| | 318 (10%) | alcohol containing | | | |
| | | carboxyl groups | | | |
| 28 | Hypermer B203 | Nonionic block | 2.49% | 0.02% | 14 |
| | | copolymer | | | |
| 29 | Atlox LPS | polycondensed fatty | 1.06% | 0.34% | 14 |
| | | acid | | | |
| 30 | Solsperse 13940 | polymeric | 2.85% | 0.04% | 14 |
| | | dispersant (aliphatic | | | |
| | | distillate) | | | |

Referring now to Tables III and IV, latex-based polymers were used for crystal growth inhibition. Both Encor 162 and latex XU 30570.51 showed less wet sieve residue wt % compared to control Instinct GF-3181 formulation after 70 and 14 days, respectively, of storage at 10° C.

TABLE III
Wet sieve testing of latex based polymeric crystal growth inhibitors post-added to the
Instinct ® formulation (GF-3181) and stored at 10° C. for crystallization stability. All
samples with polymeric crystal growth inhibitors were tested against control (GF-3181)
without any additive.

| | Crystal | | | | |
|---|---|---|---|---|---|
| | Inhibitors | | | | |
| | (post | | | Wet sieve | # of Days at |
| | addition in | | Inhibitor | residue | 10° C. |
| Sample # | GF-3181) | Chemistry | wt % | wt % | storage |
| 1 | Control | n/a | — | 0.253% | 21 |
| 1 | Control | n/a | — | 0.385% | 32 |
| 1 | Control | n/a | — | 0.425% | 70 |
| 2 | Encor 162 | high, acrylate, vinyl acrylic | 2.85% | 0.196% | 70 |
| | | copolymer latex | | | |

TABLE IV
Wet sieve testing of latex based polymeric crystal growth inhibitors post added to the
Instinct formulation (GF-3181) and stored at 10° C. for crystallization stability. All
samples with crystal inhibitors were tested against control (GF-3181) without
any additive.

| | Crystal | | | | |
|---|---|---|---|---|---|
| | Inhibitors | | | | |
| | (post | | | Wet sieve | # of Days at |
| | addition in | | Inhibitor | residue | 10° C. |
| Sample # | GF-3181) | Chemistry | wt % | wt % | storage |
| 3 | Control | n/a | — | 0.23% | 14 |
| 4 | Latex XU | styrene-butadiene polymer | 2.49% | 0.01% | 14 |
| | 30570.51 | latex | | | |
| 5 | UCAR | acrylic polymer latex | 2.51% | 0.76% | 14 |
| | Latex 418 | | | | |

While the novel technology has been described in detail in the foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

1. A microcapsule suspension formulation comprising:
(a) a suspended phase of a plurality of microcapsules, said microcapsules having a volume median particle size of from about 1 to about 10 microns, wherein a microcapsule comprises:
(1) a microcapsule wall produced by an interfacial polycondensation reaction between a polymeric isocyanate and a polyamine to form a polyurea shell having a weight percentage of about 0.2 to about 15 percent of a total weight of the microcapsule suspension formulation, and
(2) a compound encapsulated within the polyurea shell wherein said compound is 2-chloro-6-(trichloromethyl)pyridine; and
(b) an aqueous phase including at least one polymeric crystal growth inhibitor.

2. The microcapsule suspension formulation according to claim 1, wherein the at least one polymeric crystal growth inhibitor reduces formation of crystalline 2-chloro-6-(trichloromethyl)pyridine in the aqueous phase of the suspension.

3. The microcapsule suspension formulation according to claim 1, wherein the at least one polymeric crystal growth inhibitor is selected from the group consisting of acrylate polymers and copolymers, methacrylate polymers and copolymers, nonionic polymeric surfactants, anionic polymeric surfactants, polymeric dispersants, nonionic block copolymers, lignosulfonates, sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone with 1-hexadecene or with vinyl acetate, modified polyvinyl alcohols containing carboxyl groups, poly(alkylene) ethanolamides, polyvinylamines, modified styrene acrylic polymers, and latexes.

4. The microcapsule suspension formulation according to claim 1, wherein the at least one polymeric crystal growth inhibitor is selected from the group consisting of: a nonionic polymeric surfactant with a low HLB including a hydrophilic portion of polyethylene oxide (PEG) and a hydrophobic portion of poly 12-hydroxystearic acid (pHSA) or alkyd resin, a poly(isobutylene) ethanolamide, a homopolymer of hexadecyl 1-ethenyl-2-pyrrolidinone, a polyethylene-polypropylene glycol monobutyl ether, a polymeric dispersant, a nonionic block copolymer, a high acrylate, vinyl acrylic copolymer latex, and a styrene-butadiene polymer latex.

5. The microcapsule suspension formulation according to claim 1, wherein the at least one polymeric crystal growth inhibitor is selected from the group consisting of: a nonionic polymeric surfactants with a low HLB including a hydrophilic portion of polyethylene oxide (PEG) and a hydrophobic portion of poly 12-hydroxystearic acid (pHSA) or alkyd resin, a poly(isobutylene) ethanolamide, and a homopolymer of hexadecyl 1-ethenyl-2-pyrrolidinone.

6. The microcapsule suspension formulation according to claim 1, wherein the at least one polymeric crystal growth inhibitor is selected from the group consisting of: a polyethylene-polypropylene glycol monobutyl ether, a polymeric dispersant, a nonionic block copolymer, a high acrylate, vinyl acrylic copolymer latex, and a styrene-butadiene polymer latex.

7. The microcapsule suspension formulation according to claim 1, wherein the at least one polymeric crystal growth inhibitor comprises a portion of the formulation in any weight percent range selected from the group consisting of: between about 2.00 wt. % and about 3.00 wt. %, between about 1.00 wt. % and about 5.00 wt. %, between about 0.50 wt. % and about 7.50 wt. %, and between about 0.01 wt. % and about 10.00 wt. %.

8. A fertilizer composition comprising:
a nitrogen fertilizer; and
the microcapsule suspension formulation of claim 1.

9. The fertilizer composition according to claim 8 wherein the nitrogen fertilizer is an ammonium or organic nitrogen fertilizer.

10. A method of suppressing the nitrification of ammonium nitrogen in a growth medium comprising the step of:
applying the microcapsule suspension formulation of claim 1 to said growth medium.

11. The method according to claim 10, wherein the formulation is incorporated into the growth medium.

12. The method according to claim 10, wherein the formulation is applied to a growth medium surface.

13. The method according to claim 10, wherein the formulation is applied in combination with a pesticide or sequentially with a pesticide.

14. The method according to claim 10, wherein the formulation is applied with a nitrogen fertilizer.

15. The method according to claim 14, wherein the nitrogen fertilizer is urea ammonium nitrate.

16. A method for reducing crystal formation in a microcapsule suspension formulation comprising the steps of:
preparing a microcapsule suspension formulation comprising:
(a) a suspended phase of a plurality of microcapsules, said microcapsules having a volume median particle size of from about 1 to about 10 microns, wherein a microcapsule comprises:
(1) a microcapsule wall produced by an interfacial polycondensation reaction between a polymeric isocyanate and a polyamine to form a polyurea shell having a weight percentage of about 0.2 to about 15 percent of a total weight of the microcapsule suspension formulation, and
(2) a compound encapsulated within the polyurea shell wherein said compound is 2-chloro-6-(trichloromethyl)pyridine; and
(b) an aqueous phase; and
combining the microcapsule suspension formulation with at least one polymeric crystal growth inhibitor.

17. The method according to claim 16, wherein the step of combining is performed substantially simultaneously with step of preparing the microcapsule suspension.

18. The method according to according to claim 16, wherein the step of combining is performed after the step of preparing the microcapsule suspension.

19. The method according to according to claim 16, wherein the step of combining is performed during transport of the microcapsule suspension.

20. The method according to according to claim 16, wherein the at least one polymeric crystal growth inhibitor is selected from the group consisting of: acrylate polymers and copolymers, methacrylate polymers and copolymers, nonionic polymeric surfactants, anionic polymeric surfactants, polymeric dispersants, nonionic block copolymers, lignosulfonates, sulfonated kraft lignin dispersants, polyalkylene glycols and glycol ethers, homopolymers of 1-ethenyl-2-pyrrolidinone, alkylated homopolymers of 1-ethenyl-2-pyrrolidinone, copolymers of 1-ethenyl-2-pyrrolidinone with 1-hexadecene or with vinyl acetate, modified polyvinyl alcohols containing carboxyl groups, poly(alkylene) ethanolamides, polyvinylamines, modified styrene acrylic polymers, and latexes.

21. The method according to according to claim 16, wherein the at least one polymeric crystal growth inhibitor is selected from the group consisting of: a nonionic polymeric surfactant with a low HLB containing a hydrophilic portion of polyethylene oxide (PEG) and a hydrophobic portion of poly 12-hydroxystearic acid (pHSA) or alkyd resin, a poly(isobutylene) ethanolamide, a homopolymer of hexadecyl 1-ethenyl-2-pyrrolidinone, a polyethylene-polypropylene glycol monobutyl ether, a polymeric dispersant, a nonionic block copolymer, a high acrylate, vinyl acrylic copolymer latex, and a styrene-butadiene polymer latex.

22. The method according to according to claim 16, wherein the at least one polymeric crystal growth inhibitor is selected from the group consisting of: nonionic polymeric surfactants with a low HLB containing a hydrophilic portion of polyethylene oxide (PEG) and a hydrophobic portion of poly 12-hydroxystearic acid (pHSA) or alkyd resin, a poly(isobutylene) ethanolamide, and a homopolymer of hexadecyl 1-ethenyl-2-pyrrolidinone.

23. The method according to according to claim 16, wherein the at least one polymeric crystal growth inhibitor is selected from the group consisting of: polyethylene-polypropylene glycol monobutyl ethers, a polymeric dispersant, a nonionic block copolymer, a high acrylate, vinyl acrylic copolymer latex, and a styrene-butadiene polymer latex.

24. The method according to according to claim 16, wherein the at least one polymeric crystal growth inhibitor comprises a portion of the formulation in any weight percent range selected from the group consisting of:
between about 2.00 wt. % and about 3.00 wt. %, between about 1.00 wt. % and about 5.00 wt. %, between about 0.50 wt. % and about 7.50 wt. %, and between about 0.01 wt. % and about 10.00 wt. %.

25. The method according to according to claim 16, wherein the suspension comprises between about 1.00% by weight and about 3.00% by weight of the polymeric crystal growth inhibitor.

26. The method according to according to claim 16, wherein the aqueous phase comprises between about 1.00 wt. % and about 5.00 wt. % of the polymeric crystal growth inhibitor that reduces formation of crystalline 2-chloro-6-(trichloromethyl)pyridine in the aqueous phase of the suspension.

27. The method according to according to claim 16, wherein the aqueous phase comprises between about 0.5 and about 10 wt. % of a polymeric crystal growth inhibitor that reduces formation of crystalline 2-chloro-6-(trichloromethyl)pyridine in the aqueous phase of the suspension.

28. The method according to according to claim 16, further comprising combining the microcapsule suspension with an ammonium or organic nitrogen fertilizer.
